(19) United States
(12) Patent Application Publication
(10) Pub. No.: US 2014/0310214 A1
(43) Pub. Date: Oct. 16, 2014

(54) OPTIMIZED AND HIGH THROUGHPUT COMPARISON AND ANALYTICS OF LARGE SETS OF GENOME DATA

(71) Applicant: INTERNATIONAL BUSINESS MACHINES CORPORATION, Armonk, NY (US)

(72) Inventors: Robert R. Friedlander, Southbury, CT (US); James R. Kraemer, Santa Fe, NM (US); Josko Silobrcic, Boston, MA (US)

(73) Assignee: International Business Machines Corporation, Armonk, NY (US)

(21) Appl. No.: 13/861,607

(22) Filed: Apr. 12, 2013

(51) Int. Cl. G06N 3/12

(52) U.S. Cl. CPC G06N 3/126
USPC 706/13

(57) ABSTRACT

A method, computer program product and system for reconciling a plurality of surprisal data sets of a genetic sequence of an organism being generated from a surprisal data reference genome using a base reference genome. If the base reference genome is not the surprisal data reference genome indicated in the surprisal data set, the surprisal data reference genome is retrieved and compared to the base reference genome to obtain reference genome differences. If a starting location of an instance of the surprisal data set is present in the reference genome differences, the nucleotides of the instance of the surprisal data are compared to the nucleotides of the reference genome difference. If the nucleotides of the instance of the surprisal data are the same as the nucleotides of the reference genome difference, the instance of surprisal data is removed from the surprisal data set.

### BACKGROUND

The present invention relates to genomic data, and more specifically to optimized and high throughput comparison and analytics of large sets of genome data.

DNA gene sequencing of a human, for example, generates about 3 billion (3 ×100⁹) nucleotide bases. Currently, if one wishes to transmit, store or analyze this data, all 3 billion nucleotide base pairs are transmitted, stored and analyzed. The storage of the data associated with the sequencing is significantly large, requiring at least 3 gigabytes of computer data storage space to store the entire genome which includes only nucleotide sequenced data and no other data or information such as annotations. The movement of the data between institutions, laboratories and research facilities is hindered by the significantly large amount of data and the significant amount of storage necessary to contain the data.

Many times during analysis, a sequence of an organism will need to be compared to a reference genome of the organism or a surprisal data filter. There are numerous reference genomes that can be compared against a sequence of an organism.

A reference genome is a digital nucleic acid sequence database which includes numerous sequences. The sequences of the reference genome do not represent any one specific individual's genome, but serve as a starting point for broad comparisons across a specific species, since the basic set of genes and genomic regulator regions that control the development and maintenance of the biological structure and processes are all essentially the same within a species. In other words, the reference genome is a representative example of a species' set of genes.

The reference genome may be tailored depending on the analysis that may take place after obtaining the surprisal data and therefore are different from each other.

A surprisal data filter, which is associated with the identified characteristics of a generated hierarchy from reference genomes and was created by combining pieces of the reference genomes that match or correspond with identified characteristics can be tailored to be user specific and are based on user input and a hierarchy of characteristics.

When researchers come together to collaborate on a larger scale project, the surprisal data obtained from comparing a sequence of an organism to different reference genomes or surprisal data filters cannot therefore be accurately compared to each other.

### SUMMARY

According to one embodiment of the present invention, a method for reconciling a plurality of surprisal data sets of a genetic sequence of an organism using a base reference genome, each surprisal data set being generated from a surprisal data reference genome. The method comprising: a computer retrieving the base reference genome; the computer retrieving one of the plurality of surprisal data sets of the genetic sequence of the organism, the surprisal data set comprising a plurality of instances. Each of instances comprising: an indication of the surprisal data reference genome used to create the surprisal data set; a starting location of differences within the surprisal data reference genome relative to the sequence of the organism; and nucleotides from the genetic sequence of the organism which are different from a sequence of nucleotides of the surprisal data reference genome. If the base reference genome is not the surprisal data reference genome indicated in the surprisal data set: the computer retrieving the surprisal data reference genome; the computer comparing a sequence of nucleotides of the base reference genome to a sequence of nucleotides of the surprisal data reference genome to obtain reference genome differences comprising: nucleotide differences comprising nucleotides which are different between the base reference genome and the surprisal data reference genome; and a starting location of the nucleotide differences between the base reference genome and the surprisal data reference genome; the computer looking up the starting locations of each instance of the surprisal data set in the reference genome differences; if a starting location of an instance of the surprisal data set is present in the reference genome differences, the computer comparing the nucleotides of the instance of the surprisal data to the nucleotides of the reference genome difference; if the nucleotides of the instance of the surprisal data are the same as the nucleotides of the reference genome difference, the computer removing the instance of surprisal data from the surprisal data set; and the computer repeating the method for all of the instances of the surprisal data set.

According to another embodiment of the present invention, a computer program product for reconciling a plurality of surprisal data sets of a genetic sequence of an organism using a base reference genome, each surprisal data set being generated from a surprisal data reference genome. The computer program product comprising: one or more computer-readable, tangible storage devices; program instructions, stored on at least one of the one or more storage devices, to retrieve the base reference genome; program instructions, stored on at least one of the one or more storage devices, to retrieve one of the plurality of surprisal data sets of the genetic sequence of the organism, the surprisal data set comprising a plurality of instances. Each instance comprising: an indication of the surprisal data reference genome used to create the surprisal data set; a starting location of differences within the surprisal data reference genome relative to the sequence of the organism; and nucleotides from the genetic sequence of the organism which are different from a sequence of nucleotides of the surprisal data reference genome. If the base reference genome is not the surprisal data reference genome indicated in the surprisal data set: program instructions, stored on at least one of the one or more storage devices, to retrieve the surprisal data reference genome; program instructions, stored on at least one of the one or more storage devices, to compare a sequence of nucleotides of the base reference genome to a sequence of nucleotides of the surprisal data reference genome to obtain reference genome differences comprising: nucleotide differences comprising nucleotides which are different between the base reference genome and the surprisal data reference genome; and a starting location of the nucleotide differences between the base reference genome and the surprisal data reference genome; program instructions, stored on at least one of the one or more storage devices, to look up the starting locations of each instance of the surprisal data set in the reference genome differences; if a starting location of an instance of the surprisal data set is present in the reference genome differences, program instructions, stored on at least one of the one or more storage devices, to compare the nucleotides of the instance of the surprisal data to the nucleotides of the reference genome difference; if the nucleotides of the instance of the surprisal data are the same as the nucleotides of the reference genome difference, program instructions, stored on at least one of the one or more storage devices, to remove the instance of surprisal data from the surprisal data set; and program instructions, stored on at least one of the one or more storage devices, to repeat the program instructions for all of the instances of the surprisal data set.

According to another embodiment of the present invention, a system for reconciling a plurality of surprisal data sets of a genetic sequence of an organism using a base reference genome, each surprisal data set being generated from a surprisal data reference genome. The system comprising: one or more processors, one or more computer-readable memories and one or more computer-readable, tangible storage devices; program instructions, stored on at least one of the one or more storage devices for execution by at least one of the one or more processors via at least one of the one or more memories, to retrieve the base reference genome; program instructions, stored on at least one of the one or more storage devices for execution by at least one of the one or more processors via at least one of the one or more memories, to retrieve one of the plurality of surprisal data sets of the genetic sequence of the organism, the surprisal data set comprising a plurality of instances. Each instance comprising: an indication of the surprisal data reference genome used to create the surprisal data set; a starting location of differences within the surprisal data reference genome relative to the sequence of the organism; and nucleotides from the genetic sequence of the organism which are different from a sequence of nucleotides of the surprisal data reference genome. If the base reference genome is not the surprisal data reference genome indicated in the surprisal data set: program instructions, stored on at least one of the one or more storage devices for execution by at least one of the one or more processors via at least one of the one or more memories, to retrieve the surprisal data reference genome; program instructions, stored on at least one of the one or more storage devices for execution by at least one of the one or more processors via at least one of the one or more memories, to compare a sequence of nucleotides of the base reference genome to a sequence of nucleotides of the surprisal data reference genome to obtain reference genome differences comprising: nucleotide differences comprising nucleotides which are different between the base reference genome and the surprisal data reference genome; and a starting location of the nucleotide differences between the base reference genome and the surprisal data reference genome; program instructions, stored on at least one of the one or more storage devices for execution by at least one of the one or more processors via at least one of the one or more memories, to look up the starting locations of each instance of the surprisal data set in the reference genome differences; if a starting location of an instance of the surprisal data set is present in the reference genome differences, program instructions, stored on at least one of the one or more storage devices for execution by at least one of the one or more processors via at least one of the one or more memories, to compare the nucleotides of the instance of the surprisal data to the nucleotides of the reference genome difference; if the nucleotides of the instance of the surprisal data are the same as the nucleotides of the reference genome difference, program instructions, stored on at least one of the one or more storage devices for execution by at least one of the one or more processors via at least one of the one or more memories, to remove the instance of surprisal data from the surprisal data set; and program instructions, stored on at least one of the one or more storage devices for execution by at least one of the one or more processors via at least one of the one or more memories, to repeat the program instructions for all of the instances of the surprisal data set.

### BRIEF DESCRIPTION OF THE SEVERAL VIEWS OF THE DRAWINGS

FIG. 1 depicts an exemplary diagram of a possible data processing environment in which illustrative embodiments may be implemented.

FIG. 2 shows a flowchart of a method of obtaining surprisal data with a surprisal data reference genome.

FIG. 3 shows a flowchart of a method of reconciling differences between a base reference genome and a surprisal data reference genome applied to a sequence of an organism and updating the surprisal data to correspond to the base reference genome.

FIG. 4 shows a schematic of the comparison of a base reference genome to a surprisal data reference genome to obtain differences and apply the differences to surprisal data.

FIG. 5 illustrates internal and external components of a client computer and a server computer in which illustrative embodiments may be implemented

### DETAILED DESCRIPTION

The illustrative embodiments of the present invention recognize that the difference between the genetic sequence from two humans is about 0.1%, which is one nucleotide difference per 1000 base pairs or approximately 3 million nucleotide differences. The difference may be a single nucleotide polymorphism (SNP) (a DNA sequence variation occurring when a single nucleotide in the genome differs between members of a biological species), or the difference might involve a sequence of several nucleotides. The illustrative embodiments recognize that most SNPs are neutral but some, 3-5% are functional and influence phenotypic differences between species through alleles. Furthermore that approximately 10 to 30 million SNPs exist in the human population of which at least 1% are functional.

The illustrative embodiments also recognize that with the small amount of differences present between the genetic sequence from two humans, the “common” or “normally expected” sequences of nucleotides can be compressed out or removed to arrive at “surprisal data”-differences of nucleotides which are “unlikely” or “surprising” relative to the common sequences, for example of a filter.

The dimensionality of the data reduction that occurs by removing the “common” sequences is 10³, such that the number of data items and, more important, the interaction between nucleotides, is also reduced by a factor of approximately 10³—that is, to a total number of nucleotides remaining is on the order of 10³.

The illustrative embodiments also recognize that by identifying what sequences are “common” or provide a “normally expected” value within a genome, and knowing what data is “surprising” or provides an “unexpected value” relative to the normally expected value, the only data needed to recreate the entire genome in a lossless manner is the surprisal data and the genome used to obtain the surprisal data.

In the illustrative embodiments surprisal data is defined as at least one nucleotide difference that provides an “unexpected value” relative to the normally expected value of the reference genome. In other words, the surprisal data contains at least one instance of surprisal data containing at least one nucleotide difference present when comparing the sequence to the reference genome. A surprisal data set is a plurality of instances of surprisal data. The surprisal data that is actually stored in the repository preferably includes a location of the difference within the reference genome, the number of nucleotides that are different, and the actual changed nucleotides.

In the illustrative embodiments of the present invention, the term “reference genome” is defined as including surprisal data filters, which are generated hierarchy from reference genomes and was created by combining pieces of the reference genomes that match or correspond with identified characteristics can be tailored to be user specific and are based on user input and a hierarchy of characteristics.

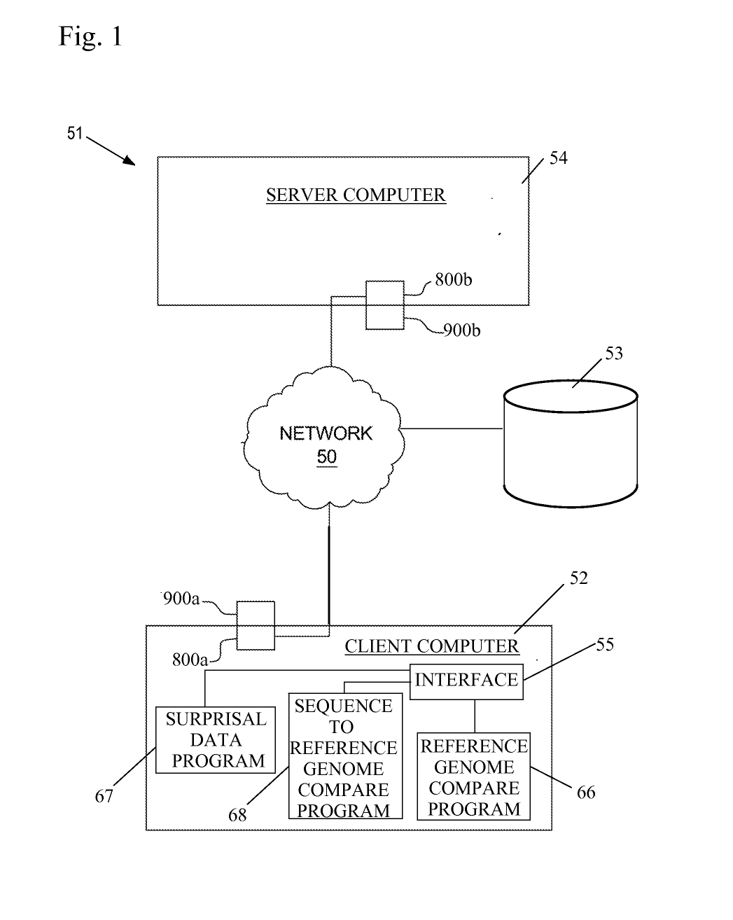

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

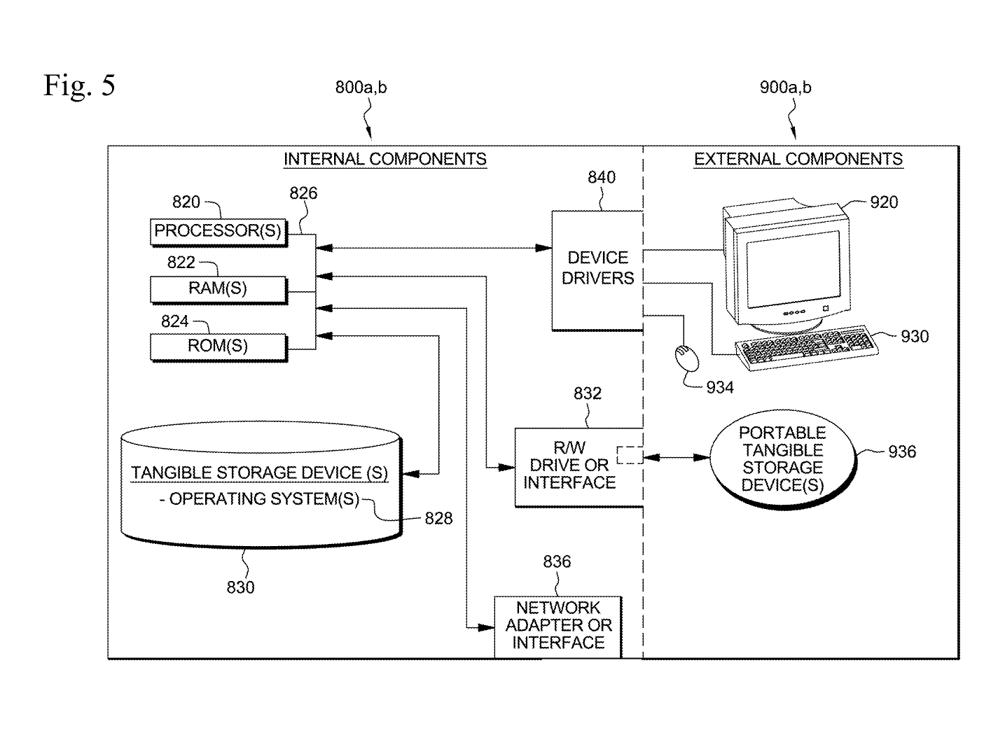

In the depicted example, client computer 52, repository 53, and server computer 54 connect to network 50. In other exemplary embodiments, network data processing system 51 may include additional client computers, storage devices, server computers, and other devices not shown. Client computer 52 includes a set of internal components 800a and a set of external components 900a, further illustrated in FIG. 5. Client computer 52 may be, for example, a mobile device, a cell phone, a personal digital assistant, a netbook, a laptop computer, a tablet computer, a desktop computer, or any other type of computing device.

Client computer 52 may contain an interface 55. Through the interface 55, different reference genomes, difference between the reference genomes, and surprisal data may be viewed by users. The interface 55 may accept commands and data entry from a user. The interface 55 can be, for example, a command line interface, a graphical user interface (GUI), or a web user interface (WUI) through which a user can access a sequence to reference genome compare program 68, a reference genome compare program 66 and/or a surprisal data program 67 on client computer 52, as shown in FIG. 1, or alternatively on server computer 54.

In the depicted example, server computer 54 provides information, such as boot files, operating system images, and applications to client computer 52. Server computer 54 can compute the information locally or extract the information from other computers on network 50. Server computer 54 includes a set of internal components 800b and a set of external components 900b illustrated in FIG. 5.

Program code, reference genomes, surprisal data and programs such as a reference genome compare program 66, a sequence to reference genome compare program 68, and/or a surprisal data program 67 may be stored on at least one of one or more computer-readable tangible storage devices 830 shown in FIG. 5, on at least one of one or more portable computer-readable tangible storage devices 936 as shown in FIG. 5, on repository 53 connected to network 50, or downloaded to a data processing system or other device for use.

For example, program code, reference genomes, surprisal data, and programs such as a reference genome compare program 66, sequence to reference genome compare program 68, and/or a surprisal data program 67 may be stored on at least one of one or more tangible storage devices 830 on server computer 54 and downloaded to client computer 52 over network 50 for use on client computer 52. Alternatively, server computer 54 can be a web server, and the program code, reference genomes, surprisal data and programs such as a reference genome compare program 66, sequence to reference genome compare program 68, and/or a surprisal data program 67 may be stored on at least one of the one or more tangible storage devices 830 on server computer 54 and accessed on client computer 52. Reference genome compare program 66, sequence to reference genome compare program 68, and/or surprisal data program 67 can be accessed on client computer 52 through interface 55. In other exemplary embodiments, the program code, reference genomes, surprisal data and programs such as reference genome compare program 66, sequence to reference genome compare program 68, and surprisal data program 67 may be stored on at least one of one or more computer-readable tangible storage devices 830 on client computer 52 or distributed between two or more servers.

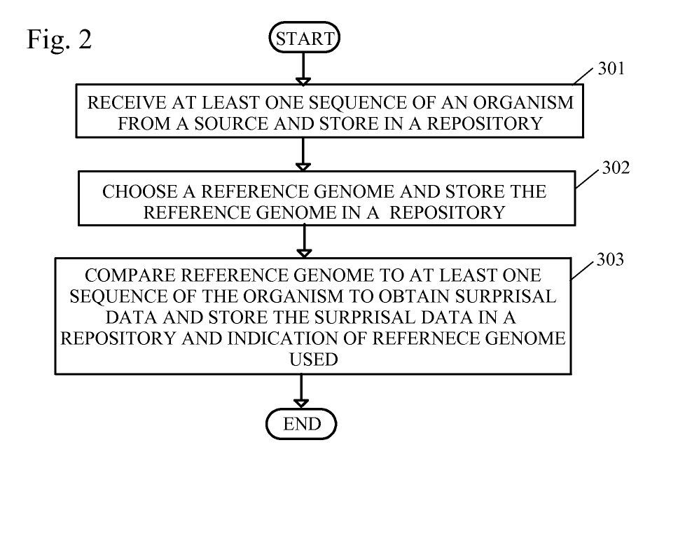

FIG. 2 shows a flowchart of a method of obtaining surprisal data according to an illustrative embodiment.

In a first step, the sequence to reference genome compare program 68 receives at least one sequence of an organism from a source and stores the at least one sequence in a repository (step 301). The repository may be repository 53 as shown in FIG. 1. The source may be a sequencing device. The sequence may be a DNA sequence, an RNA sequence, or a nucleotide sequence. The organism may be a fungus, microorganism, human, animal or plant.

Based on the organism from which the at least one sequence is taken, the sequence to reference genome compare program 68 chooses and obtains at least one reference genome and stores the reference genome in a repository (step 302).

The sequence to reference genome compare program 68 compares the at least one sequence to the reference genome to obtain surprisal data and stores only the surprisal data in a repository 53 (step 303). The surprisal data is defined as at least one nucleotide difference that provides an “unexpected value” relative to the normally expected value of the reference genome sequence. In other words, the surprisal data contains at least one instance of surprisal data containing at least one nucleotide difference present when comparing the sequence to the reference genome. Multiple instances of the surprisal data may be grouped into a surprisal data set. The surprisal data that is actually stored in the repository preferably includes a location of the difference within the reference genome, the number of nucleic acid bases that are different, the actual changed nucleic acid bases, and an indication of the reference genome used. Storing the number of bases which are different provides a double check of the method by comparing the actual bases to the reference genome bases to confirm that the bases really are different.

The method of FIG. 2 may be repeated using different reference genomes and/or surprisal data filters on a sequence of an organism.

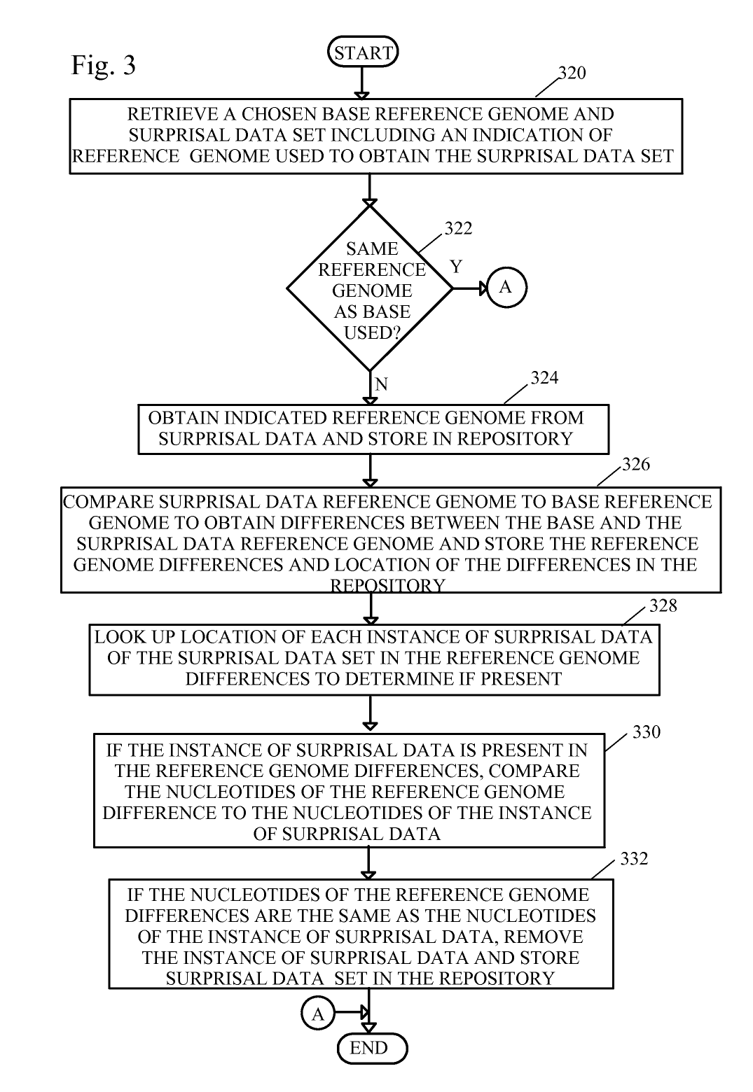

FIG. 3 shows a flowchart of a method of reconciling differences between a base reference genome and a surprisal data reference genome applied to a sequence of an organism and updating the surprisal data to correspond to the base reference genome according to an illustrative embodiment.

In a first step, a chosen base reference genome and surprisal data set with a reference genome indication are retrieved (step 320), for example by the reference genome compare program 66. The chosen base reference genome is preferably the reference genome in which all of the other reference genomes are to be compared to reconcile any and all surprisal data that may already have been generated to ensure that research or work moving forward is being compared accurately to a same starting point.

If the base reference genome is the same as the reference genome indicated by the surprisal data, hereafter referred to as “surprisal data reference genome” (step 322), the method ends. If the base reference genome is not the same as the surprisal data reference genome (step 322), the surprisal data reference genome is obtained (step 324), for example by the reference genome compare program 66 and stored in a repository, for example repository 53.

The sequence of nucleotides of the base reference genome is compared to sequence of nucleotides of the surprisal data reference genome to obtain reference genome differences and the starting location of the differences, for example through the reference genome compare program 66, with the reference genome differences and the starting locations stored in a repository (step 326), for example repository 53. Next, the location of each instance of surprisal data of the surprisal data set is looked up within the reference genome differences to determine if locations of the instances of surprisal data are present within the reference genome differences (step 328), for example through the surprisal data program 67.

If a location of an instance of the surprisal data is present at the same location as a reference genome differences, the nucleotide(s) of the reference genome difference and the nucleotide(s) of the instance of surprisal data are compared (step 330), for example through the surprisal data program 67. If the nucleotide(s) of the reference genome difference are the same as the nucleotide(s) of the instance of surprisal data, the instance of surprisal data is removed from the surprisal data set (step 332), since this instance is no longer surprising and the reconciled surprisal data with “common” surprisal data is stored in the repository, for example through the surprisal data program 67 in repository 53. Steps 328, 330 and 332 may repeat for each instance of a surprisal data set. The entire method of FIG. 3 may repeat for other surprisal data sets.

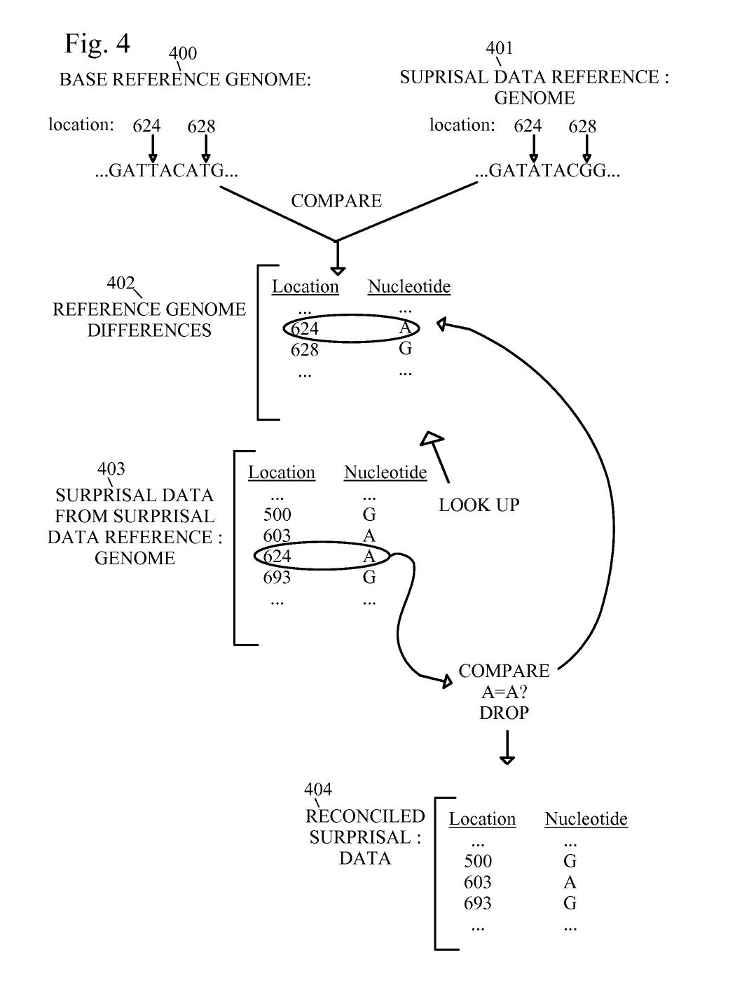

FIG. 4 shows a schematic of comparing reference genomes and altering the surprisal data. A portion of a sequence of a base reference genome 400, and a portion of a sequence of a surprisal data reference genome 401 are shown. These sequences are purely for example only. The sequence of the base reference genome 400 is compared to the sequence of the surprisal data reference genome 401 as in step 326 of FIG. 3. In this example, a reference genome difference 402 between base reference genome 400 and surprisal data reference genome 401 is present at locations/positions 624 and 628. The starting location of the instances of surprisal data are looked up within the reference genome differences to determine if they are present within the reference genome differences as in step 328 of FIG. 3. In this example, a surprisal data instance does occur at location 624 of the surprisal data set and a reference genome difference is also present at location 624.

If an instance of the surprisal data within the surprisal data set is present within the reference genome differences, in this example location 624, the nucleotide(s) at this location is compared to the nucleotide(s) of the reference genome differences as in step 330 of FIG. 3. So, a nucleotide of A of the surprisal data instance at location 624 is compared to a nucleotide of “A” at location 624 of the reference genome differences. If the nucleotides are the same, the instance of surprisal data at the location is removed, and the reconciled surprisal data is stored in a repository as in step 332 of FIG. 3. The reconciled surprisal data 404 no longer contains surprisal data at location 624.

It should be noted that in this example, a reference genome difference was also found at location 628. Since location 628 was not present in the surprisal data set, this difference is of no consequence relative to the surprisal data set.

FIG. 5 illustrates internal and external components of client computer 52 and server computer 54 in which illustrative embodiments may be implemented. In FIG. 5, client computer 52 and server computer 54 include respective sets of internal components 800a, 800b, and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, a reference genome compare program 66, a sequence to reference genome compare program 68 and a surprisal data program 67 are stored on one or more of the computer-readable tangible storage devices 830 for execution by one or more of the processors 820 via one or more of the RAMs 822 (which typically include cache memory). In the embodiment illustrated in FIG. 5, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. A reference genome compare program 66, a sequence to reference genome compare program 68, and a surprisal data program 67 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. A reference genome compare program 66, a sequence to reference genome compare program 68, and a surprisal data program 67 can be downloaded to client computer 52 and server computer 54 from an external computer via a network (for example, the Internet, a local area network or other, wide area network) and network adapter or interface 836. From the network adapter or interface 836, a reference genome compare program 66, a sequence to reference genome compare program 68, and a surprisal data program 67 are loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

A reference genome compare program 66, a sequence to reference genome compare program 68, and a surprisal data program 67 can be written in various programming languages including low-level, high-level, object-oriented or non object-oriented languages. Alternatively, the functions of a reference genome compare program 66, a sequence to reference genome compare program 68, and a surprisal data program 67 can be implemented in whole or in part by computer circuits and other hardware (not shown).

Based on the foregoing, a computer system, method, and program product have been disclosed for reconciling a plurality of surprisal data sets of a genetic sequence of an organism using a base reference genome, each surprisal data set being generated from a surprisal data reference genome. However, numerous modifications and substitutions can be made without deviating from the scope of the present invention. Therefore, the present invention has been disclosed by way of example and not limitation.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for reconciling a plurality of surprisal data sets of a genetic sequence of an organism using a base reference genome, each surprisal data set being generated from a surprisal data reference genome, comprising:
a computer retrieving the base reference genome;
the computer retrieving one of the plurality of surprisal data sets of the genetic sequence of the organism, the surprisal data set comprising a plurality of instances, each comprising:
an indication of the surprisal data reference genome used to create the surprisal data set;
a starting location of differences within the surprisal data reference genome relative to the sequence of the organism; and
nucleotides from the genetic sequence of the organism which are different from a sequence of nucleotides of the surprisal data reference genome;
if the base reference genome is not the surprisal data reference genome indicated in the surprisal data set:
the computer retrieving the surprisal data reference genome;
the computer comparing a sequence of nucleotides of the base reference genome to a sequence of nucleotides of the surprisal data reference genome to obtain reference genome differences comprising:
nucleotide differences comprising nucleotides which are different between the base reference genome and the surprisal data reference genome; and
a starting location of the nucleotide differences between the base reference genome and the surprisal data reference genome;
the computer looking up the starting locations of each instance of the surprisal data set in the reference genome differences;
if a starting location of an instance of the surprisal data set is present in the reference genome differences, the computer comparing the nucleotides of the instance of the surprisal data to the nucleotides of the reference genome difference;
if the nucleotides of the instance of the surprisal data are the same as the nucleotides of the reference genome difference, the computer removing the instance of surprisal data from the surprisal data set; and
the computer repeating the method for all of the instances of the surprisal data set.

2. The method of claim 1, wherein the base reference genome is a surprisal data filter comprising pieces of reference genomes that match or correspond with identified characteristics tailored based on user input and a hierarchy of characteristics.

3. The method of claim 1, wherein the organism is a mammal.

4. A computer program product for reconciling a plurality of surprisal data sets of a genetic sequence of an organism using a base reference genome, each surprisal data set being generated from a surprisal data reference genome, the computer program product comprising:
one or more computer-readable, tangible storage devices;
program instructions, stored on at least one of the one or more storage devices, to retrieve the base reference genome; program instructions, stored on at least one of the one or more storage devices, to retrieve one of the plurality of surprisal data sets of the genetic sequence of the organism, the surprisal data set comprising a plurality of instances, each comprising:
an indication of the surprisal data reference genome used to create the surprisal data set;
a starting location of differences within the surprisal data reference genome relative to the sequence of the organism; and
nucleotides from the genetic sequence of the organism which are different from a sequence of nucleotides of the surprisal data reference genome;
if the base reference genome is not the surprisal data reference genome indicated in the surprisal data set:
program instructions, stored on at least one of the one or more storage devices, to retrieve the surprisal data reference genome;
program instructions, stored on at least one of the one or more storage devices, to compare a sequence of nucleotides of the base reference genome to a sequence of nucleotides of the surprisal data reference genome to obtain reference genome differences comprising:
nucleotide differences comprising nucleotides which are different between the base reference genome and the surprisal data reference genome; and
a starting location of the nucleotide differences between the base reference genome and the surprisal data reference genome;
program instructions, stored on at least one of the one or more storage devices, to look up the starting locations of each instance of the surprisal data set in the reference genome differences;
if a starting location of an instance of the surprisal data set is present in the reference genome differences, program instructions, stored on at least one of the one or more storage devices, to compare the nucleotides of the instance of the surprisal data to the nucleotides of the reference genome difference;
if the nucleotides of the instance of the surprisal data are the same as the nucleotides of the reference genome difference, program instructions, stored on at least one of the one or more storage devices, to remove the instance of surprisal data from the surprisal data set; and
program instructions, stored on at least one of the one or more storage devices, to repeat the program instructions for all of the instances of the surprisal data set.

5. The computer program product of claim 4, wherein the base reference genome is a surprisal data filter comprising pieces of reference genomes that match or correspond with identified characteristics tailored based on user input and a hierarchy of characteristics.

6. The computer program product of claim 4, wherein the organism is a mammal.

7. A computer system for reconciling a plurality of surprisal data sets of a genetic sequence of an organism using a base reference genome, each surprisal data set being generated from a surprisal data reference genome, the system comprising:
one or more processors, one or more computer-readable memories and one or more computer-readable, tangible storage devices;
program instructions, stored on at least one of the one or more storage devices for execution by at least one of the one or more processors via at least one of the one or more memories, to retrieve the base reference genome;
program instructions, stored on at least one of the one or more storage devices for execution by at least one of the one or more processors via at least one of the one or more memories, to retrieve one of the plurality of surprisal data sets of the genetic sequence of the organism, the surprisal data set comprising a plurality of instances, each comprising:
an indication of the surprisal data reference genome used to create the surprisal data set;
a starting location of differences within the surprisal data reference genome relative to the sequence of the organism; and
nucleotides from the genetic sequence of the organism which are different from a sequence of nucleotides of the surprisal data reference genome;
if the base reference genome is not the surprisal data reference genome indicated in the surprisal data set:
program instructions, stored on at least one of the one or more storage devices for execution by at least one of the one or more processors via at least one of the one or more memories, to retrieve the surprisal data reference genome;
program instructions, stored on at least one of the one or more storage devices for execution by at least one of the one or more processors via at least one of the one or more memories, to compare a sequence of nucleotides of the base reference genome to a sequence of nucleotides of the surprisal data reference genome to obtain reference genome differences comprising:
nucleotide differences comprising nucleotides which are different between the base reference genome and the surprisal data reference genome; and
a starting location of the nucleotide differences between the base reference genome and the surprisal data reference genome;
program instructions, stored on at least one of the one or more storage devices for execution by at least one of the one or more processors via at least one of the one or more memories, to look up the starting locations of each instance of the surprisal data set in the reference genome differences;
if a starting location of an instance of the surprisal data set is present in the reference genome differences, program instructions, stored on at least one of the one or more storage devices for execution by at least one of the one or more processors via at least one of the one or more memories, to compare the nucleotides of the instance of the surprisal data to the nucleotides of the reference genome difference;
if the nucleotides of the instance of the surprisal data are the same as the nucleotides of the reference genome difference, program instructions, stored on at least one of the one or more storage devices for execution by at least one of the one or more processors via at least one of the one or more memories, to remove the instance of surprisal data from the surprisal data set; and
program instructions, stored on at least one of the one or more storage devices for execution by at least one of the one or more processors via at least one of the one or more memories, to repeat the program instructions for all of the instances of the surprisal data set.

8. The system of claim 7, wherein the base reference genome is a surprisal data filter comprising pieces of reference genomes that match or correspond with identified characteristics tailored based on user input and a hierarchy of characteristics.

9. The system of claim 7, wherein the organism is a mammal.
